(19) United States
(12) Patent Application Publication
(10) Pub. No.: US 2014/0162701 A1
(43) Pub. Date: Jun. 12, 2014

(54) MOBILE DEVICE LOCATION FINDER

(71) Applicant: PLANTRONICS, INC., Santa Cruz, CA (US)

(72) Inventors: Herbert D. Jellinek, Aptos, CA (US); Douglas K. Rosener, Santa Cruz, CA (US); Gregory H. Miller, Scotts Valley, CA (US); Todd W. Zazelenchuk, Santa Cruz, CA (US); Jan Caldarella, Capitola, CA (US); Ken Comstock, Scotts Valley, CA (US); John B. Ledingham, Scotts Valley, CA (US)

(73) Assignee: PLANTRONICS, INC., Santa Cruz, CA (US)

(21) Appl. No.: 13/710,171

(22) Filed: Dec. 10, 2012

(51) Int. Cl. H04W 4/02

(52) U.S. Cl. CPC H04W 4/021
USPC 455/456.6

(57) ABSTRACT

Methods and apparatuses for mobile device location finding are disclosed. In one example, an event notification is received at a first device. A location of the first device is determined responsive to the notification, and the location of the first device is correlated to a location of a second device. The location of the second device is indicated on a user viewable display.

### BACKGROUND OF THE INVENTION

Most people today carry multiple wireless devices, including mobile phones (e.g., smartphones), tablet computing devices, personal digital assistants, and headsets. It is not uncommon for people to misplace or lose track of the location of one or more of their devices, particularly if the device has a small form factor and is used in a variety of locations. Wireless devices have become smaller in order to meet consumer demands and to improve portability and convenience, leading to easier misplacement and making them more difficult to find when lost. For example, people often misplace wireless headsets or other wireless accessories that are associated with their mobile phone. The devices may be left at an office, in a car, or somewhere in a home location. They may be left on a cluttered table, in a bag, or in a clothes pocket.

In the prior art, to help the user keep track of a headset, some form of an alert has been used to notify the user it has been separated from the mobile phone, such as a beeper or vibration alert. Usually this involves tracking the signal strength of a radio link between the devices. This can prevent the loss of the devices. However, this solution is problematic because it requires the user to be paying attention to the alarms. In some cases they may be distracted, and not hear or feel the alert. In other cases, the alert feature may not be turned on or the device may be in a silent operation mode. Another problem with this solution may be that the user purposefully separates himself from the device, ignores the warning, and then cannot remember where the device is. Understandably, users do not wish to spend time looking for misplaced devices. Furthermore, where a device stores sensitive personal information, it is important for the user to locate the device as quickly and easily as possible.

As a result, improved methods and apparatuses for determining mobile device locations are needed.

### BRIEF DESCRIPTION OF THE DRAWINGS

The present invention will be readily understood by the following detailed description in conjunction with the accompanying drawings, wherein like reference numerals designate like structural elements.

FIG. 1A illustrates a system for indicating a device location in one example state.

FIG. 1B illustrates a system for indicating a device location in one example state.

FIG. 2 illustrates a simplified block diagram of the devices shown in FIG. 1.

FIG. 3 illustrates a screenshot shown on a device display in one example.

FIG. 4 illustrates a screenshot shown on a device display in one example.

FIG. 5 illustrates a screenshot shown on a device display in one example.

FIG. 6 is a flow diagram illustrating a method for indicating a user device location in one example.

FIG. 7 is a flow diagram illustrating a method for indicating a user device location in a further example.

### DESCRIPTION OF SPECIFIC EMBODIMENTS

Methods and apparatuses for tracking the location of electronic devices and indicating device locations to users are disclosed. The following description is presented to enable any person skilled in the art to make and use the invention. Descriptions of specific embodiments and applications are provided only as examples and various modifications will be readily apparent to those skilled in the art. The general principles defined herein may be applied to other embodiments and applications without departing from the spirit and scope of the invention. Thus, the present invention is to be accorded the widest scope encompassing numerous alternatives, modifications and equivalents consistent with the principles and features disclosed herein. For purpose of clarity, details relating to technical material that is known in the technical fields related to the invention have not been described in detail so as not to unnecessarily obscure the present invention.

In one example, a method for indicating a user device location includes receiving a notification of an event at a first device, determining a location of the first device responsive to the notification, and correlating the location of the first device to a location of a second device. The method further includes indicating the location of the second device on a user viewable display.

In one example, a mobile device includes a user interface display, a first wireless communications transceiver, a second wireless communications transceiver operable to form a wireless connection with a wireless device local to the mobile device, and a processor. The mobile device further includes a memory storing a device finder application executable by the processor configured to indicate the location of the wireless device on the user interface display, the location associated with an event at the mobile device.

In one example, a computer readable storage memory storing instructions that when executed by a computer cause the computer to perform a method for call control includes receiving a notification of an event at a first device, determining a location of the first device responsive to the notification, and correlating the location of the first device to a location of a second device. The method further includes indicating the location of the second device on a user viewable display.

In one example, a method for indicating a user device location includes forming a wireless connection between a first device and a second device, and monitoring a movement of the first device during the wireless connection between the first device and the second device. The method further includes monitoring a signal strength data associated with the wireless connection, and mapping the movement of the first device together with the signal strength data.

In one embodiment, the location of a mobile phone and an associated headset are tracked. When any one of four eligible headset events take place (1) headset connect, (2) headset disconnect, (3) call made, or (4) call received, the location is recorded by the phone and stored for display to the user to assist the user in locating either the mobile phone or the headset. For any of the four events, a map location indicates where the mobile phone was at that moment of the event. In a Bluetooth embodiment, the headset is within 10 m of the phone in order for the event to be registered since that is the effective Bluetooth range. In one example, the location of calls received and made are the locations where those calls ended. The time and date for all four events is shown in an event log which may be viewed by the user on a device display. In one example, this is the mobile phone display. In a further example, the location data and event log are uploaded to a networked computing device so that the user can view the information on a remote device.

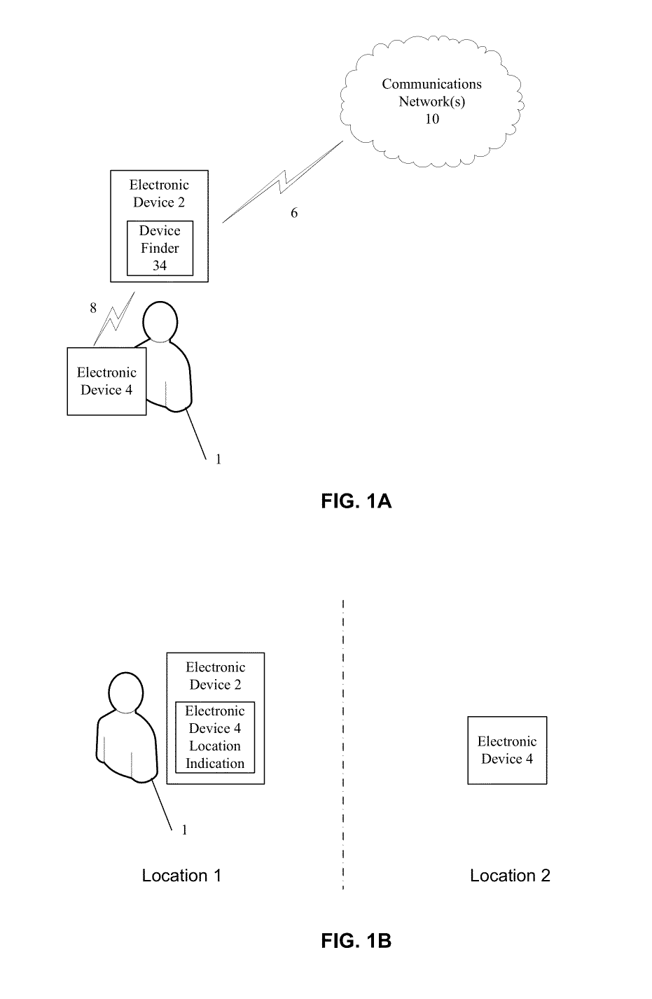

FIG. 1A illustrates a system for indicating a device location in one example state. The system includes an electronic device 2 and an electronic device 4. Electronic device 2 is capable of communications with one or more communication network(s) 10 over network connection 6. For example, communication network(s) 10 may include an Internet Protocol (IP) network, cellular communications network, public switched telephone network, IEEE 802.11 wireless network, or any combination thereof. For example, electronic device 2 includes a wireless transceiver to connect to an IP network via a wireless Access Point utilizing an IEEE 802.11 communications protocol or a wireless transceiver to connect to a cellular communications network where network connection 6 is a wireless cellular communications link.

Electronic device 2 and electronic device 4 include wireless transceivers configured for communication therebetween over wireless connection 8. In the state shown in FIG. 1A, electronic device 2 and electronic device 4 are in proximity to a user 1 at a user 1 location. Electronic device 2 and electronic device 4 are intended to represent a wide range of devices. Electronic device 2 may, for example, be any mobile computing device, including without limitation a mobile phone, laptop, PDA, headset, tablet computer, or smartphone. In one example, electronic device 4 is a body worn device. For example, electronic device 4 may be a headset.

Electronic device 2 includes a device finder application 34 configured to indicate the location of electronic device 2, electronic device 4, or both electronic device 2 and electronic device 4 upon request by the user 1. In operation, electronic device 2 utilizing device finder application 34 receives notification of an event. An event may include, for example, formation of a wireless connection 8 between electronic device 2 and electronic device 4, termination of the wireless connection 8 between electronic device 2 and electronic device 4, a termination of a call received by electronic device 2, or a termination of a call made by electronic device 2.

Responsive to the notification of the event, electronic device 2 determines its location. In one example, electronic device 2 determines its current speed responsive to the notification of the event, wherein the speed of the electronic device 2 is utilized in determining the location of electronic device 2 and electronic device 4. Electronic device 2 correlates its determined location to a location of electronic device 4. For example, the current location of electronic device 4 is assigned the determined location of electronic device 2. In one example, the location of electronic device 4 is a geographic area within which it is predicted to be located.

In one example, a Google Maps API is used which utilizes an Android phone's “location services” to compute the map location of the mobile phone. These services consist of 2 options: GPS and Network (Cell Phone Location and Wi-Fi). The best source from whichever service is turned on and providing data is utilized. The combination of data supplied by one or more of the primary three location services (GPS, WiFi, and cell network) provide a high level of accuracy for logged events. The event log includes the actual date and time of the connect/disconnect events, and the end time of the call made/received to provide the user with meaningful data points to assist the user in locating their devices.

In one example, the accuracy of the location of the user is optimized to interpret the users' speed of movement at the time of the event in the case that the user is in motion at the time of the event. For example, the user may be driving. An initial location is approximated based on the phone location services, and an accuracy circle (also referred to herein as a “confidence circle” or “target circle”) is adjusted based on the user speed and time passed since the event was initiated to show a predicted geographic area where the device has a high probability of being located.

In a mobile phone embodiment, the mobile phone determines the user's speed of motion (e.g., stationary, walking, driving) in order to calculate a reasonable circle of confidence or margin of error when the target circle (i.e., the predicted geographic area) is drawn on the map. If the user is stationary and a good location fix from Google maps is obtained, the target circle will be small. If the user is in motion and/or the location fix is not as reliable, the target circle radius is increased for where the event might have taken place. The phone considers the distance traveled and time elapsed between the location references collected to determine whether the user is stationary, walking or driving. It then applies a coefficient to the confidence circle in the event that the user is driving to accommodate some additional margin of error.

In one example, the following equation is used to predict the geographic area within which the mobile phone is located:

adjustedAccuracy=accuracy( )(1*accuracyCoefficient)+(timeDifference/TimeUtility.SECOND)* mBestLocationInTimeWindow.getSpeed( );

This equation may be used when an immediate location is not available and one of the older stored locations neighboring the actual event must be used. Although an attempt to collect the immediate location for the current event may be made, the location service (e.g., Android) may not be able to provide a quality location on demand. When this happens, a default is made to the next high quality location that was recorded and stored in the phone's memory. Time difference in the equation is the time elapsed between the original location recorded and the current event.

For example, in one usage scenario, a user is working at his office desk with his phone on and a disconnected, powered off headset on the desk. The device finder application is installed and running in the background on his phone. Periodically, GPS is collecting a location fix of the phone's location. The user also has network location services turned on so the location data being sent to the cloud periodically is highly accurate. The user receives a call on his mobile phone and he answers it using the phone. He decides to transfer the call to his headset so he powers on the headset. It automatically connects and the call is transferred to the headset. The device finder application records this connection event in an event log at the moment it occurred and attempts to collect an immediate location fix for the event, using the best of the GPS and network locations collected.

The user continues the call and walks to his car and drives toward home. The next location fix takes place and is evaluated against the most recent location fix in memory. The selected location and its corresponding log time are compared to the current location and corresponding log time to determine the “BestlocationinTimeWindow” variable. Depending on that selection, the “timeDifference”/“TimeUtility” calculates whether the user is most likely stationary, or in motion and sets the “accuracyCoefficient” accordingly to result in the best possible “adjusted accuracy”.

FIG. 1B illustrates a system for indicating a device location in one example state. In the state shown in FIG. 1B, electronic device 4 has been separated from user 1 and user 1 would like to determine the location of electronic device 4. The user 1 and electronic device 2 are located at a location 1 and electronic device 4 is located at a location 2, where the location 2 is unknown to user 1. Upon request of the user 1, the user 1 may view the location of electronic device 4 on a display of electronic device 2. In a further example, electronic device 2 may upload data gathered by device finder application 34 to a cloud based application (e.g., on the Internet). In this embodiment, user 1 may view the location of electronic device 4 on any computing device display which can access the cloud, such as a laptop or desktop computer. The user 1 may also view the location of electronic device 2. This embodiment is advantageous where the user 1 does not have immediate access to or know the location of electronic device 2, electronic device 4, or both electronic device 2 and electronic device 4.

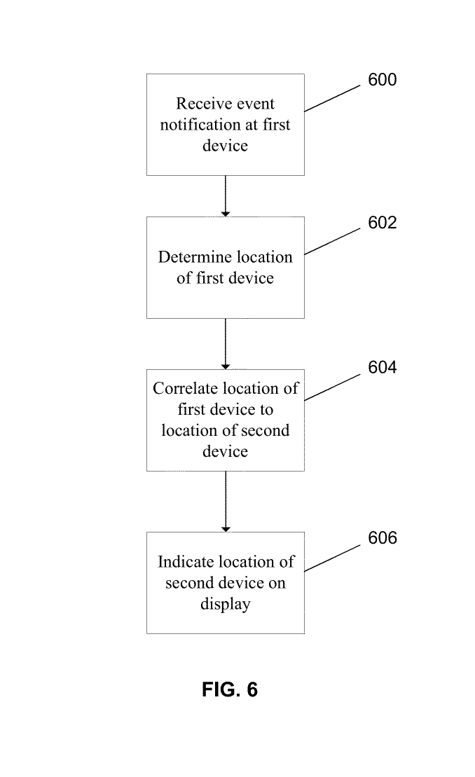

In one example implementation, the trigger event for a location determination is the formation of the wireless connection 8 between electronic device 2 and electronic device 4. Electronic device 2 receives signal strength data associated with wireless connection 8, such as received signal strength indication (RSSI) data, and also receives continual polled location data of electronic device 2. Electronic device 2 also receives a second event notification when the wireless connection 8 between electronic device 2 and electronic device 4 is terminated. Upon request by user 1, electronic device 2 may generate and display a map showing electronic device 2 location data, the location data including a location of the formation of the wireless connection 8, a location of the termination of the wireless connection 8, and a movement between the location of the formation of the wireless connection 8 and the location of the termination of the wireless connection 8. An indication of the signal strength data is shown with electronic device 2 location data. FIG. 6 illustrates a screenshot shown on a device display in one example of such a map.

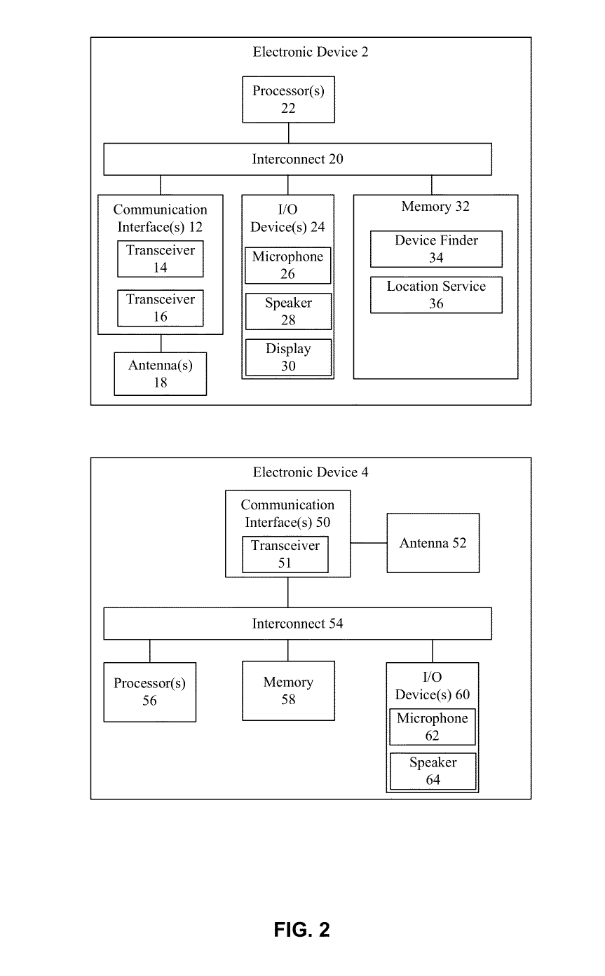

FIG. 2 illustrates a simplified block diagram of the electronic device 2 and electronic device 4 shown in FIGS. 1A and 1B. In one example, the electronic device 2 and the electronic device 4 each include a two-way RF communication device having data communication capabilities. The electronic device 2 and electronic device 4 may have the capability to communicate with other computer systems via a local or wide area network.

Electronic device 2 includes input/output (I/O) device(s) 24 configured to interface with the user, including a microphone 26 operable to receive a user voice input or other audio, a speaker 28, and a display device 30. I/O device(s) 24 may also include additional input devices, such as a keyboard, touch screen, etc., and additional output devices. In some embodiments, I/O device(s) 24 may include one or more of a liquid crystal display (LCD), an alphanumeric input device, such as a keyboard, and/or a cursor control device. I/O device(s) 24 include a user interface operable to receive a user request to enter a device finder mode.

The electronic device 2 includes a processor 22 configured to execute code stored in a memory 32. Processor 22 executes a device finder application 34 and a location service module 36 to perform functions described herein. Although shown as separate applications, device finder application 34 and location service module 36 may be integrated into a single application.

Utilizing device finder application 34, electronic device 2 is operable to track the location of electronic device 4 so that the user 1 can subsequently locate electronic device 4 if desired. In one example, the device finder application 34 is configured to indicate the location of a wireless electronic device 4 on the display device 30, the location associated with an event at the electronic device 2. For example, the location may be indicated on a map shown on display device 30. In one embodiment, the location of the electronic device 4 may be a geographic area within which the electronic device 4 is predicted to be located.

In operation, electronic device 2 utilizes location service module 36 to determine the present location of electronic device 2 upon the occurrence of a predetermined event. For example, electronic device 2 may determine and store its location in a log of events upon formation of a wireless connection using transceiver 16, termination of a wireless connection on the transceiver 16, termination of a call received by the electronic device 2 on the transceiver 14, or a termination of a call made by the electronic device 2 on the transceiver 14. The log may include the date and time of each event, duration of the call or connection, etc.

In one example, electronic device 2 is a mobile device utilizing the Android operating system and the electronic device 4 is a wireless headset. The location service module 36 utilizes location services offered by the Android device (GPS, WiFi, and cellular network) to determine and log the location of the mobile device and in turn the connected headset, which is deemed to have the same location as the mobile device when connected. In further examples, one or more of GPS, WiFi, or cellular network may be utilized to determine location. The GPS may be capable of determining the location of electronic device 2 to within a few inches. In certain cases, the GPS may not be able to provide a location if a satellite signal is blocked or obstructed by buildings, tunnels, or trees. The cellular network may be used to determine the location of electronic device 2 utilizing cellular triangulation methods.

While only a single processor 22 is shown, electronic device 2 may include multiple processors and/or co-processors, or one or more processors having multiple cores. The processor 22 and memory 32 may be provided on a single application-specific integrated circuit, or the processor 22 and the memory 32 may be provided in separate integrated circuits or other circuits configured to provide functionality for executing program instructions and storing program instructions and other data, respectively. Memory 32 also may be used to store temporary variables or other intermediate information during execution of instructions by processor 22.

Memory 32 may include both volatile and non-volatile memory such as random access memory (RAM) and read-only memory (ROM). Device event data for electronic device 2 and electronic device 4 may be stored in memory 32, including electronic device 2 call data and connection data between electronic device 2 and electronic device 4. For example, this data may include time and date data, and location data for each type of event described herein.

Electronic device 2 includes communication interface(s) 12, one or more of which may utilize antenna(s) 18. The communications interface(s) 12 may also include other processing means, such as a digital signal processor and local oscillators. Communication interface(s) 12 include a transceiver 14 and a transceiver 16. In one example, communications interface(s) 12 include one or more short-range wireless communications subsystems which provide communication between electronic device 2 and different systems or devices. For example, transceiver 16 may be a short-range wireless communication subsystem operable to communicate with electronic device 4 using a personal area network or local area network. The short-range communications subsystem may include an infrared device and associated circuit components for short-range communication, a near field communications (NFC) subsystem, a Bluetooth subsystem including a transceiver, or an IEEE 802.11 (WiFi) subsystem in various non limiting examples.

In one example, transceiver 14 is a long range wireless communications subsystem, such as a cellular communications subsystem. Transceiver 14 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Interconnect 20 may communicate information between the various components of electronic device 2. Instructions may be provided to memory 32 from a storage device, such as a magnetic device, read-only memory, via a remote connection (e.g., over a network via communication interface(s) 12) that may be either wireless or wired providing access to one or more electronically accessible media. In alternative examples, hard-wired circuitry may be used in place of or in combination with software instructions, and execution of sequences of instructions is not limited to any specific combination of hardware circuitry and software instructions.

Electronic device 2 may include operating system code and specific applications code, which may be stored in non-volatile memory. For example the code may include drivers for the electronic device 2 and code for managing the drivers and a protocol stack for communicating with the communications interface(s) 12 which may include a receiver and a transmitter and is connected to antenna(s) 18. Communication interface(s) 12 provides a wireless interface for communication with electronic device 4.

Similarly, electronic device 4 includes communication interface(s) 50, antenna 52, memory 58, and I/O device(s) 60 substantially similar to that described above for electronic device 2. Input/output (I/O) device(s) 60 are configured to interface with the user, and include a microphone 62 operable to receive a user voice input and a speaker 64 to output audio.

The electronic device 4 includes an interconnect 54 to transfer data and a processor 56 is coupled to interconnect 35 to process data. The processor 56 may execute a number of applications that control basic operations, such as data and voice communications via the communication interface(s) 50. Communication interface(s) 50 include a wireless transceiver 51 operable to communication with a communication interface(s) 12 at electronic device 2. The block diagrams shown for electronic device 2 and electronic device 4 do not necessarily show how the different component blocks are physically arranged on electronic device 2 or electronic device 4. For example, transceivers 14, 16, and 51 may be separated into transmitters and receivers.

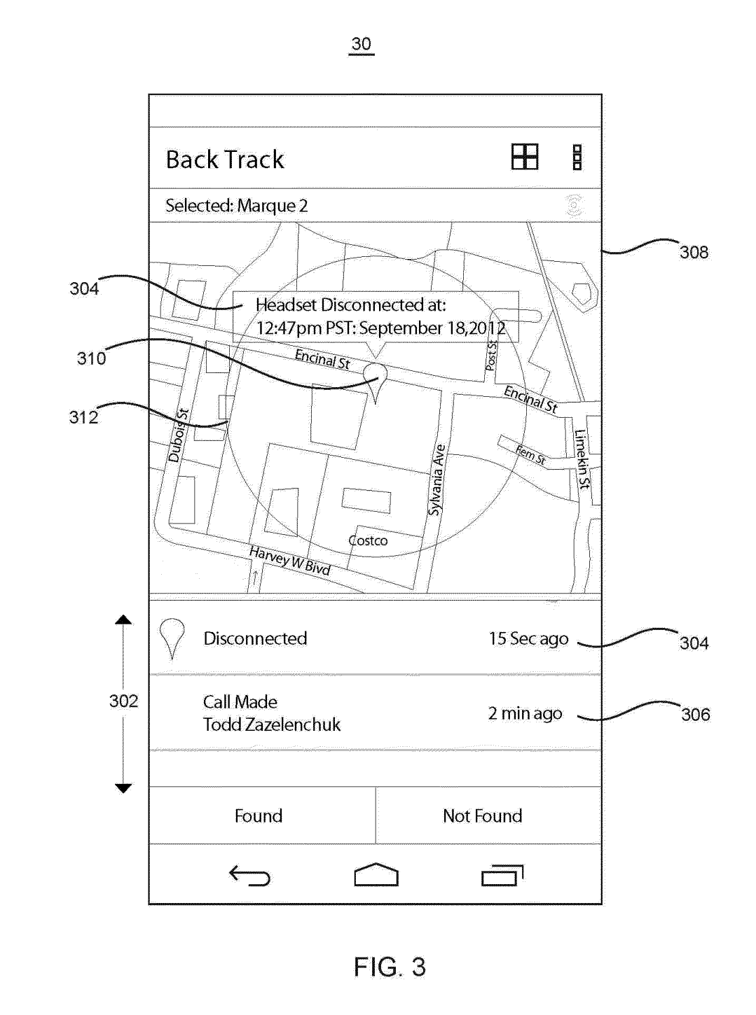

FIG. 3 illustrates a screenshot shown on a display device 30 of electronic device 2 in one example. In the screenshot shown in FIG. 3, electronic device 4 is a headset, and the location of the headset is indicated on map 308 by a map marker 310 (e.g., a location pin). The screenshot includes an event log 302 below the map 308 showing recent events 304, 306, etc. as well as the time the event occurred (e.g., 15 seconds ago, 2 minutes ago, etc.). In the example screenshot, the user 1 has selected to view the location of the headset at event 304, where the details of event 304 are shown associated with map marker 310. In further examples, the user 1 may select to view the location of the headset at event 306 or other events in event log 302. In addition to map marker 310, the map 308 may show a geographic area 312 (e.g., target circle) in which the headset is predicted to be with a certain probability.

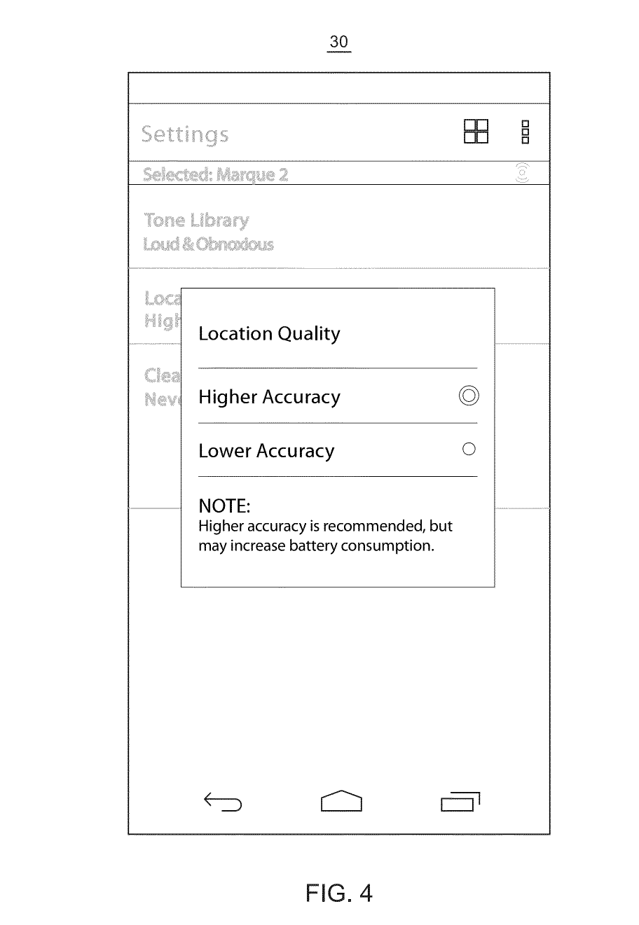

FIG. 4 illustrates a screenshot shown on a display device 30 in a further example. In the screenshot shown in FIG. 4, the user 1 is presented with an option to select the accuracy of the location services provided by electronic device 2 in identifying the location of electronic device 4. Where the user 1 selects the “Higher Accuracy” option, location services module 36 increases the frequency with which the location is determined so that when a device event occurs, a higher quality reading available. This is advantageous over waiting for an event to occur before taking any location readings, since a reliable reading at that moment of the event may not be available. By having other neighboring readings logged, the best available reading can be used, either before the event or at the time of the event. This however has an impact on battery usage so while it offers the best quality of location, the user may also select the “Lower Accuracy” option where the location services are polled less often.

In a further example of device tracking, referred to as “bread-crumbing” by the inventors, the electronic device 2 is a mobile phone and the electronic device 4 is an associated wireless headset. The mobile phone is constantly journaling to an event log its location and the headset's relative signal strength, connection status, and if available, the worn state (i.e., worn or not worn) of the headset or other accessory. This event log can be kept on the mobile phone or be transmitted to an internet cloud-based database.

When the user leaves the headset on a desk, the worn state may change. If they power it off, the connection will be lost. If left on, as they walk away, the decreasing RSSI and potential connection break are also documented to the cloud. A user can go to a cloud-based application, and see on a map where these events occurred, noting the location associated with an extremely weak signal or link break. They can also subscribe to periodic alarms sent by the cloud application in case they missed the alarm when the link was broken. This information can also be sent to UC and IT managers that are concerned with replacing lost hardware.

If both devices are still on and connected, and the user turns on the cloud-based application mapping facility, the user can continue to map the RSSI data as they move about. In the case of a lost mobile, the user can activate a similar mapping method as in the second process on the cloud-based application. If the headset or other accessory has orientation tracking (e.g., a headset with a magnetometer), this information can aid the finding process and if the headset has audio output, the user can be guided audibly to the best location to find the headset. Advantageously, this allows the headset to find and be found with their associated mobile phone. It helps the user's that do not heed the warning of device separation, or do not have that feature turned on, find their missing device.

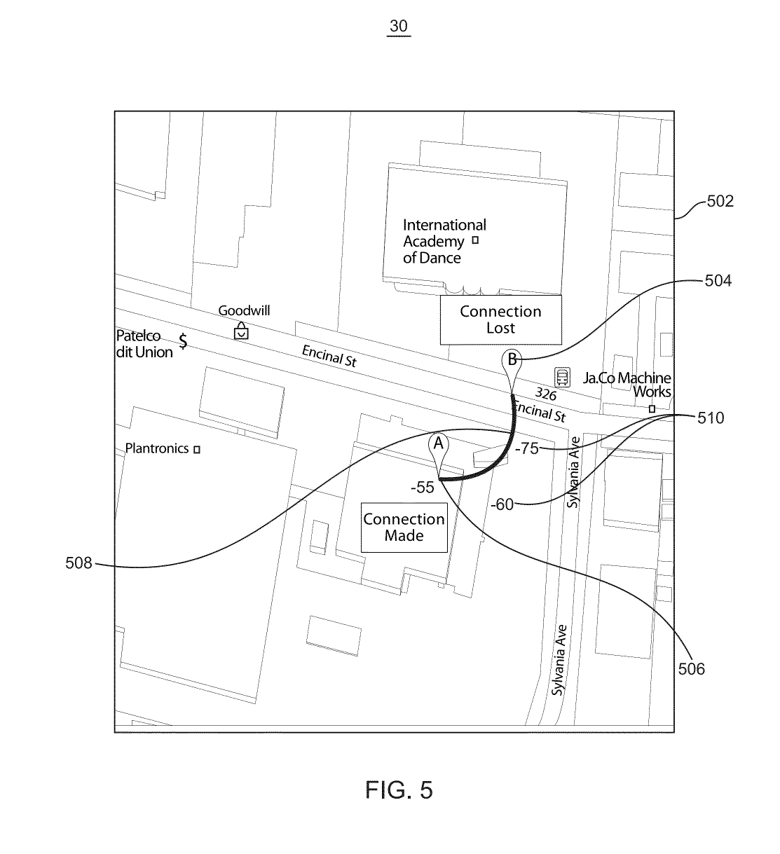

FIG. 5 illustrates a screenshot shown on a display in an example of the “bread-crumbing” process. In the screenshot shown in FIG. 5, electronic device 2 is a mobile phone and electronic device 4 is a headset, and the location of the disconnection between the headset and mobile phone is indicated on map 502 by a map marker 504. User 1 can lose either the headset or the mobile phone or both. When devices are no longer connected, the separation between devices can be large. In this case, if the device locations are tracked until separation occurs, the user 1 may use map 502 to locate either device.

To generate map 502, the mobile phone periodically stores its location and headset RSSI to a database (on the mobile phone or in the cloud), so that it is possible to see where the devices parted ways at a later time. If the database is on the mobile phone, the user 1 can bring up map 502 with the map marker 504 showing where the connection was broken. If desired, granularity of the lost location can be improved by using RSSI values and their associated locations. When displayed on the map 502, the RSSI values show where the last strongest value was and the path 508 that led to connection loss. In the case of a power down of the device, map marker 504 indicates at least the last known location.

To obtain RSSI values, the mobile phone continuously queries the headset RSSI, or the headset reports it periodically to the mobile phone. RSSI on demand is already available as a command in the headset from the mobile phone. Alternatively, in a further example, the mobile phone may measure the RSSI directly without the need for a headset query. The mobile phone stores this data locally and/or sends this periodic data along with its current coordinates (latitude and longitude) to a cloud-based application. A website can be used to access the cloud data, and the locally stored data on the mobile phone can use a mobile phone application.

For example, in one usage scenario, the user 1 has lost their headset or mobile phone or both. Even if they have one of the devices, perhaps the other's battery ran down, or it is too far away. If the user 1 has their mobile phone, they can bring up the device finder application 34 and see a map 502 that shows the last RSSI values 510 before the headset lost connection. If the user 1 only has the headset or neither device, the user 1 logs into a personal website that displays the map 502 of the last received RSSI values 510 and their location. Looking at the map 502, they can see where the devices last recorded their location.

FIG. 6 is a flow diagram illustrating a method for indicating a user device location in one example. At block 600, an event notification is received at a first device. In one example, the event is a formation of a wireless connection between the first device and the second device, a termination of a wireless connection between the first device and the second device, a termination of a call received by the first device, or a termination of a call made by the first device.

At block 602, a location of the first device is determined responsive to the event notification. At block 604, the location of the first device is correlated to a location of a second device. In one example, the first device is a mobile phone and the second device is a wireless headset.

At block 606, the location of the second device is indicated on a user viewable display. In one example, the first device includes a user viewable display and the location of the second device is shown on this display. In a further example, the user viewable display is on a third device, such as remote personal computer accessing the Internet, where the location of the second device has been uploaded to the cloud. In one example, the location of the second device is a geographic area within which the second device is predicted to be located. In a further example, the speed of the first device is determined responsive to the notification of the event, where the speed of the first device is utilized in determining the location of the second device.

In one embodiment, the event notification is notification of a formation of a wireless connection between the first device and the second device. A signal strength data associated with the wireless connection, a plurality of location data associated with the first device, and a second event notification comprising termination of the wireless connection are received. A first device location data, including a location of the formation of the wireless connection, a location of the termination of the wireless connection, a movement between the location of the formation of the wireless connection, and the location of the termination of the wireless connection are mapped. An indication of the signal strength data is shown with first device location data.

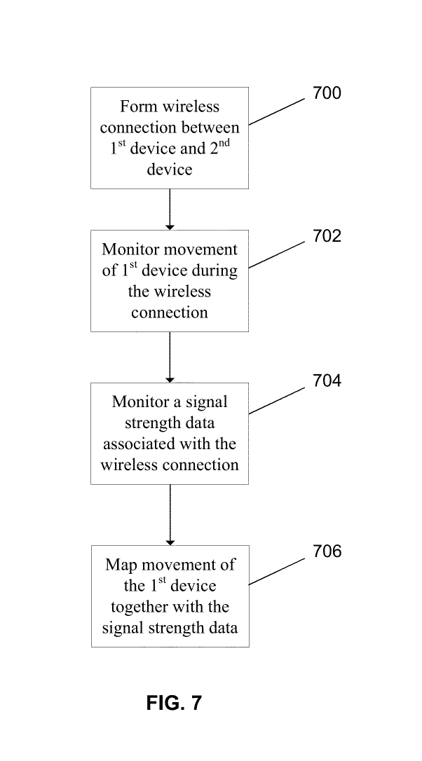

FIG. 7 is a flow diagram illustrating a method for indicating a user device location in a further example. At block 700, a wireless connection between a first device and a second device is formed. In one example, the first device is a mobile phone and the second device is a headset. In one example, the wireless connection is a Bluetooth connection.

At block 702, a movement of the first device during the wireless connection between the first device and the second device is monitored. In one example, the movement is monitored utilizing global positioning system data or cellular communications network data. At block 704, a signal strength data associated with the wireless connection is monitored. At block 706, the movement of the first device together with the signal strength data is mapped. A location where the wireless connection was formed may be mapped, and the location where the wireless connection was terminated may be mapped.

While the exemplary embodiments of the present invention are described and illustrated herein, it will be appreciated that they are merely illustrative and that modifications can be made to these embodiments without departing from the spirit and scope of the invention. Thus, the scope of the invention is intended to be defined only in terms of the following claims as may be amended, with each claim being expressly incorporated into this Description of Specific Embodiments as an embodiment of the invention.

What is claimed is:

1. A method for indicating a user device location comprising:
receiving a notification of an event at a first device;
determining a location of the first device responsive to the notification;
correlating the location of the first device to a location of a second device; and
indicating the location of the second device on a user viewable display.

2. The method of claim 1, wherein the first device is a mobile phone and the second device is a wireless headset.

3. The method of claim 1, wherein the event is a formation of a wireless connection between the first device and the second device, a termination of a wireless connection between the first device and the second device, a termination of a call received by the first device, or a termination of a call made by the first device.

4. The method of claim 1, wherein the first device comprises the user viewable display.

5. The method of claim 1, wherein the location of the second device is a geographic area within which the second device is predicted to be located.

6. The method of claim 1, further comprising determining a speed of the first device responsive to the notification of the event, wherein the speed of the first device is utilized in determining the location of the second device.

7. The method of claim 1, wherein the user viewable display is on a third device.

8. The method of claim 1, wherein the notification is a formation of a wireless connection between the first device and the second device, the method further comprising:
receiving a signal strength data associated with the wireless connection;
receiving a plurality of location data associated with the first device;
receiving a second notification comprising termination of the wireless connection; and
mapping a first device location data, the first device location data including a location of the formation of the wireless connection, a location of the termination of the wireless connection, a movement between the location of the formation of the wireless connection and the location of the termination of the wireless connection, wherein an indication of the signal strength data is shown with first device location data.

9. A mobile device comprising:
a user interface display;
a first wireless communications transceiver;
a second wireless communications transceiver operable to form a wireless connection with a wireless device local to the mobile device;
a processor; and
a memory storing a device finder application executable by the processor configured to indicate a location of the wireless device on the user interface display, the location associated with an event at the mobile device.

10. The mobile device of claim 9, wherein the wireless device is a headset.

11. The mobile device of claim 9, wherein the event comprises formation of a wireless connection using the second wireless communications transceiver, termination of a wireless connection on the second wireless communications transceiver, termination of a call received by the mobile device on the first wireless communications transceiver, or a termination of a call made by the mobile device on the first wireless communications transceiver.

12. The mobile device of claim 9, wherein the location is indicated on a map shown on the user interface display.

13. The mobile device of claim 9, wherein the location of the wireless device is a geographic area within which the wireless device is predicted to be located.

14. The mobile device of claim 9, wherein the first wireless communications transceiver is a cellular communications transceiver or IEEE 802.11 transceiver and the second wireless communications transceiver is a Bluetooth transceiver.

15. A computer readable storage memory storing instructions that when executed by a computer cause the computer to perform a method for call control comprising:
receiving a notification of an event at a first device;
determining a location of the first device responsive to the notification;
correlating the location of the first device to a location of a second device; and
indicating the location of the second device on a user viewable display.

16. The computer readable storage memory of claim 15, wherein the first device is a mobile phone and the second device is a wireless headset.

17. The computer readable storage memory of claim 15, wherein the event is a formation of a wireless connection between the first device and the second device, a termination of a wireless connection between the first device and the second device, a termination of a call received by the first device, or a termination of a call made by the first device.

18. The computer readable storage memory of claim 15, wherein the first device comprises the user viewable display.

19. The computer readable storage memory of claim 15, wherein the location of the second device is a geographic area within which the second device is predicted to be located.

20. A method for indicating a user device location comprising:
forming a wireless connection between a first device and a second device;
monitoring a movement of the first device during the wireless connection between the first device and the second device;
monitoring a signal strength data associated with the wireless connection; and
mapping the movement of the first device together with the signal strength data.

21. The method of claim 20, further comprising terminating the wireless connection between the first device and the second device and mapping a termination location of the first device.

22. The method of claim 20, wherein the movement is monitored utilizing global positioning system data or cellular communications network data.

23. The method of claim 20, wherein the wireless connection is a Bluetooth connection.

24. The method of claim 20, further comprising mapping a location where the wireless connection is formed.

25. The method of claim 20, wherein the first device is a mobile phone and the second device is a headset.
